(19) United States
(12) Patent Application Publication
(10) Pub. No.: US 2021/0115867 A1
(43) Pub. Date: Apr. 22, 2021

(54) SAFETY DEVICE FOR VEHICLE ACCELERATOR

(71) Applicant: Wen-Yi Wu, New Taipei City (TW)

(72) Inventor: Wen-Yi Wu, New Taipei City (TW)

(21) Appl. No.: 16/705,167

(22) Filed: Dec. 5, 2019

(30) Foreign Application Priority Data
Oct. 17, 2019 (TW) 108213694

(51) Int. Cl. F02D 41/12

(52) U.S. Cl. CPC F02D 41/123; F02D 2200/602

(57) ABSTRACT

The safety device for vehicle accelerator includes a control member. The control member includes a microprocessor, a first variable resistor, and a buzzer. The control member is electrically connected to a vehicle's engine controller and acceleration pedal detector. When the acceleration pedal is suddenly depressed, the acceleration pedal detector sends a signal to the control member to engage the buzzer. The control member then converts and transmits the signal to the engine controller so that the engine controller reduces fuel injection, slows the vehicle down. The control member then turns off the buzzer.

### BACKGROUND OF THE INVENTION

### (a) Technical Field of the Invention

The present invention is generally related to vehicle safety, and more particular to a safety device preventing unintended vehicle acceleration.

### (b) Description of the Prior Art

Unintended vehicle acceleration usually occurs when a vehicle is idle ready to run. It is a condition unexpected by the vehicle driver and often leading to traffic incidents.

Most unintended vehicle acceleration is usually caused by improper operation from the driver. An ordinary vehicle has its acceleration pedal and brake pedal next to each other. A driver therefore may accidentally step on the acceleration pedal while he/she actually intends to brake.

Currently vehicles do not have an alert and protection device out of the factory guarding against the sudden depression of acceleration pedal.

### SUMMARY OF THE INVENTION

Therefore, the present invention teaches a safety device for vehicle accelerator, which includes a control member. The control member includes a microprocessor, a first variable resistor, and a buz7er. The control member is electrically connected to a vehicle's engine controller and acceleration pedal detector. When the acceleration pedal is suddenly depressed, the acceleration pedal detector sends a signal to the control member to engage the buzzer. The control member then converts and transmits the signal to the engine controller so that the engine controller reduces fuel injection, slows the vehicle down. The control member then turns off the blunt

The control member further includes at least a connection socket. The control member is housed in a casing member. The casing member provides a through opening corresponding to the connection socket which allows detachable connection from a transmission cable. The transmission cable includes a first connector, a second connector, and a third connector. The first connector is connected to the connection socket. The second connector is connected to the acceleration pedal detector. The third connector is connected to the engine controller.

As described above, the installation of the safety device is therefore easy and convenient.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a circuit diagram showing a control member of a safety device for vehicle accelerator according to an embodiment of the present invention.

FIG. 2 is a circuit diagram showing the connection of the control member of FIG. 1 to a vehicle's acceleration pedal detector and engine controller.

FIG. 3 is a perspective diagram showing the appearance of the control member of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

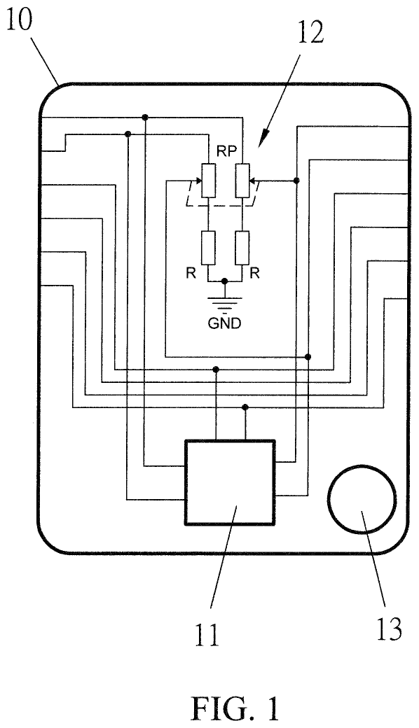

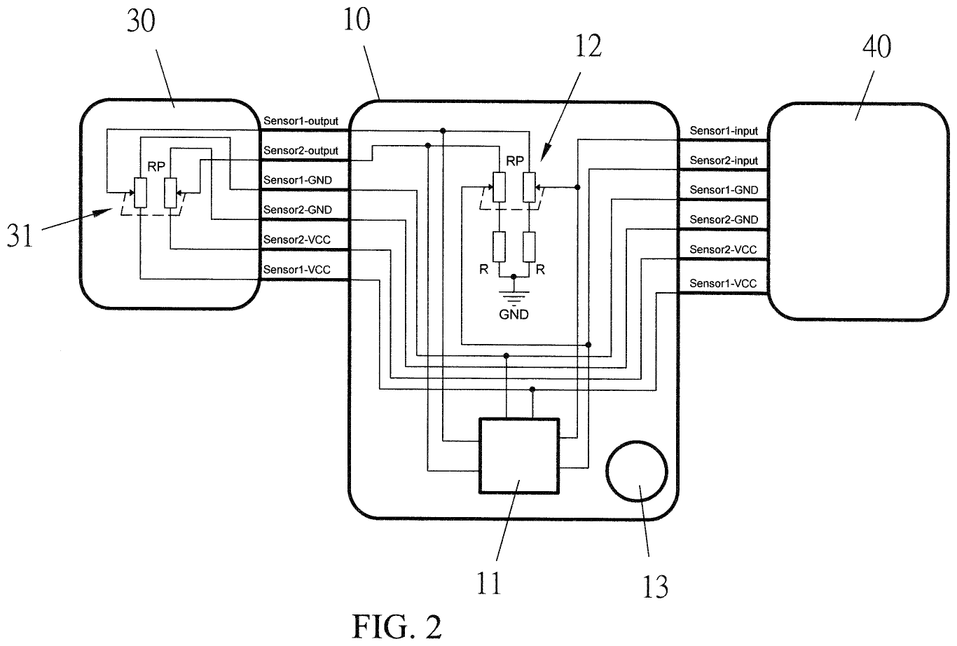

As shown in FIGS. 1 and 2, a safety device according to an embodiment of the present invention includes a control member 10, which in turn includes a microprocessor 11, a first variable resistor 12, and a buzzer 13.

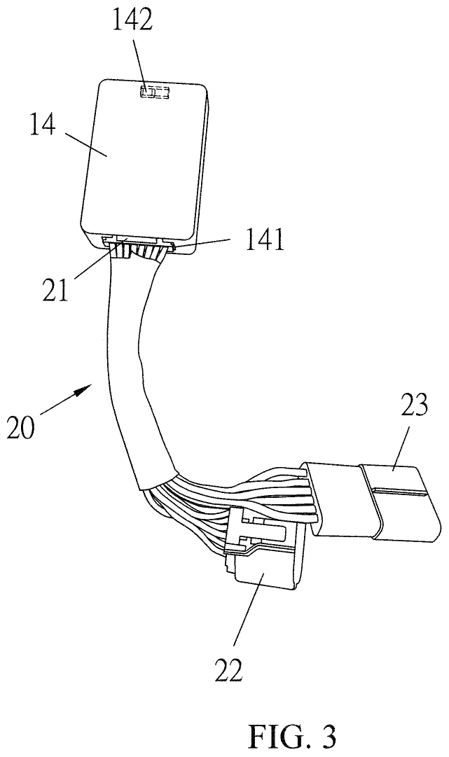

As shown in FIG. 3, the control member 10 further has at least a connection socket (not shown), the control member 10 is housed inside a casing member 14. The casing member 14 has a through opening 141 corresponding to the connection socket.

The control member 10 further includes an activation element 142 electrically connected to the microprocessor 11, the first variable resistor 12, and the buzzer 13. The activation element 142 provides selective activation and deactivation to the control member 10.

The connection socket provides detachable connection from a transmission cable 20. The transmission cable 20 includes a first connector 21, a second connector 22, and a third connector 23. The first connector 21 is plugged into the connection socket. The second connector 22 is connected to an acceleration pedal detector 30 of a vehicle. The third connector 23 is connected to an engine controller 40 of the vehicle. The first connector 21 may be integrally fumed with the control member 10.

After installing the safety device, the engine controller 40 may turn on the vehicle's engine failure indicator if the control member 10 undergoes short circuitry.

In other words, the control member 10 is electrically connected to the vehicle's acceleration pedal detector 30 and engine controller 40, respectively. Inside the acceleration pedal detector 30, there is a second variable resistor 31. The microprocessor 11 and first variable resistor 12 connect and control the second variable resistor 31 through a SPI (Serial and Parallel Interface) protocol. The microprocessor 11 provides high and low voltage levels to drive the buzzer 31 through an 10 (Input and Output) port.

When the acceleration pedal is suddenly pressed (i.e., the acceleration pedal is quickly depressed less than or equal to one second), the second variable resistor 31 of the acceleration pedal detector 30 sends a signal to the control member 10 so that the second variable resistor 31 and the first variable resistor 12 operate synchronously. The first variable resistor 12 then sends a signal to the microprocessor 14 to engage the buzzer 13 so that the driver of the vehicle is alerted about the acceleration pedal's status. The control member 10 then converts and transmits the signal to the engine controller 40. The engine controller 40 reduces fuel injection to idle the vehicle. The control member 10 then turns off the bu77er 13.

The first variable resistor 12 and the second variable resistor 31 are for detecting the acceleration pedal's at least a first position and at least a second position, and for detecting a moving speed of the acceleration pedal. When the acceleration pedal moves from the first position to the second position within a second, the buzzer 13 is turned on by the control member 10. The control member 10 converts and transmits the signal to the engine controller 40 to reduce fuel injection, and turns off the buzzer 13 when the vehicle is slowed down.

When a driver intentionally slows down the vehicle by releasing the acceleration pedal, the control member 10 automatically turns off the buzzer 13, and stops sending signal to the engine controller 40, so that the control member 10 is restored to a normal operating mode.

The control member 10 further includes a sensitivity adjustment element adjusting a detection sensitivity of the control member 10.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

1. A safety device for vehicle accelerator, comprising a control member, wherein the control member comprises a microprocessor, a first variable resistor, an activation element, and a buzzer;
the control member is electrically connected in between a vehicle's engine controller and acceleration pedal detector;
the microprocessor detects a moving speed of the acceleration pedal from the acceleration pedal detector; the microprocessor turns on the buzzer when the moving speed of the acceleration pedal is within one second moving from a first position to a second position; the microprocessor converts and transmits a signal from the acceleration pedal detector to the engine controller to reduce fuel injection to slow the vehicle down; and the microprocessor turns off the buzzer; and
the activation element electrically connected to the microprocessor, the first variable resistor, and the buzzer for selective activation and deactivation to the control member.

2. The safety device according to claim 1, wherein the control member further comprises at least a connection socket; the control member is housed in a casing member; and the casing member has a through opening corresponding to the connection socket.

3. The safety device according to claim 2, wherein the connection socket provides a detachable connection to a transmission cable; the transmission cable comprises a first connector, a second connector, and a third connector; the first connector is connected to the connection socket; the second connector is connected to the acceleration pedal detector; and the third connector is connected to the engine controller.

4. The safety device according to claim 2, wherein the connection socket is connected to a transmission cable; the transmission cable comprises a first connector, a second connector, and a third connector; the first connector is integrally formed with the connection socket; the second connector is detachably connected to the acceleration pedal detector; and the third connector is detachably connected to the engine controller.

5. The safety device according to claim 1, wherein the acceleration pedal detector comprises a second variable resistor inside; the second variable resistor and the first variable resistor operate synchronously; and the first variable resistor sends a signal to the microprocessor.

6.-7. (canceled)

8. The safety device according to claim 1, wherein, when the control member is short-circuited, the vehicle's engine failure indicator is turned on by the engine controller.

9. The safety device according to claim 1, wherein the control member further comprises a sensitivity adjustment element for adjusting a sensitivity level of the first variable resistor of the control member.

10. (canceled)
